(19) United States
(12) Patent Application Publication
(10) Pub. No.: US 2013/0132598 A1
(43) Pub. Date: May 23, 2013

(54) METHOD AND SYSTEM FOR MANAGING AND DELIVERING DATA

(71) Applicants: Barrett Comiskey, Taguig (PH); Robert Scot Hastings, Taguig (PH); Logan Adermatt, Taguig (PH); Alana Calvin, Taguig (PH); Loren Heiman, Taguig (PH); Chi Lee, Taguig (PH); Jake Schnackenberg, Taguig (PH); Samuel Tarng, Taguig (PH)

(72) Inventors: Barrett Comiskey, Taguig (PH); Robert Scot Hastings, Taguig (PH); Logan Adermatt, Taguig (PH); Alana Calvin, Taguig (PH); Loren Heiman, Taguig (PH); Chi Lee, Taguig (PH); Jake Schnackenberg, Taguig (PH); Samuel Tarng, Taguig (PH)

(73) Assignee: MIGO, Grand Cayman (KY)

(21) Appl. No.: 13/697,881

(22) PCT Filed: May 14, 2011
(86) PCT No.: PCT/US2011/036559

§ 371 Date: Feb. 5, 2013

Related U.S. Application Data
(60) Provisional application No. 61/334,704, filed on May 14, 2010.
(60) Provisional application No. 61/334,703, filed on May 14, 2010.

(51) Int. Cl. H04L 29/06

(52) U.S. Cl. CPC H04L 29/06
USPC 709/229

(57) ABSTRACT

In accordance with at least some embodiments of the present disclosure, methods and apparatuses for delivering data to a plurality of destination nodes are presented. One example method may include in response to a request to deliver the data, determining a first transport for a first destination node based on availability of and/or network condition associated with the first transport, sending the data to the first destination node via the first transport, and determining whether to resend the data based on a delivery option extracted from the request.

### CROSS-REFERENCE TO RELATED APPLICATIONS

This application claims the benefit of the U.S. provisional patent application Ser. No. 61/334,703 and 61/334,704, both filed May 14, 2010, each of which is herein incorporated by reference in its entirety.

### TECHNICAL FIELD

The present disclosure relates generally to networking technologies and more specifically methods and systems for managing and delivering data.

### BACKGROUND

Unless otherwise indicated herein, the approaches described in this section are not prior art to the claims in this application and are not admitted to be prior art by inclusion in this section.

Distributing large amounts of data in emerging markets is presented with challenges that cannot be easily addressed by traditional distribution technologies. Some of these challenges include lack of connectivity options that are priced for the general public in these markets, lack of support for reliable high-speed communications, significant regional variations in available networking and computing infrastructure, and significant piracy related issues for copyrighted content.

### SUMMARY

Embodiments of the present disclosure set forth methods and systems for managing and delivering data. Specifically, one embodiment of the present disclosure sets forth a method, which includes, in response to a request to deliver the data, determining a first transport for a first destination node based on availability of and/or network condition associated with the first transport, sending the data to the first destination node via the first transport, and determining whether to resend the data based on a delivery option extracted from the request.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 illustrates a simplified block diagram of an example system in which one embodiment of a content management and delivery device (CMDD) may be configured to operate in;

FIG. 2 illustrates an example embodiment of the asynchronous content distribution network (ACDN) of FIG. 1;

FIG. 3 is a flow chart of an illustrative embodiment of a process for a node controller to deliver data to one or more destination nodes;

FIG. 4 illustrates an example local edge access point in which one embodiment of a CMDD may be configured to operate in;

FIG. 5 is a flow chart of an illustrative embodiment of a method for maintaining a registered subscriber account;

FIG. 6 illustrates an example token; and

FIG. 7 is a flow chart of an illustrative embodiment of a method for transferring customized content to a subscriber device, all arranged in accordance with at least some embodiments of the present disclosure.

### DETAILED DESCRIPTION

The technical details set forth below enable a person skilled in the art to implement at least some embodiments of the present disclosure to manage and deliver data. In this disclosure, a “subscriber” broadly refers to an individual or an entity, whose identity has been authenticated, whose account has been verified, and who is authorized to receive content related services. A “transport” or a “transport network” broadly refers to a data transfer mechanism between nodes. Some example transports correspond to, without limitation, transport of storage media (e.g., hard drives, memory devices, Universal Serial Bus (USB) drives, Secured Digital (SD) cards, and others) containing data and data transfer over Public Internet or private networks via various access modes (e.g., cellular modems, digital subscriber line (DSL) modems, Very Small Aperture Terminals (VSATs), cable modems, Worldwide Interoperability for Microwave Access (WiMAX) devices, and others). A “courier” broadly refers to a person or an entity who delivers physical items to physical locations. Some example couriers include, DHL, FedEx, UPS, and others.

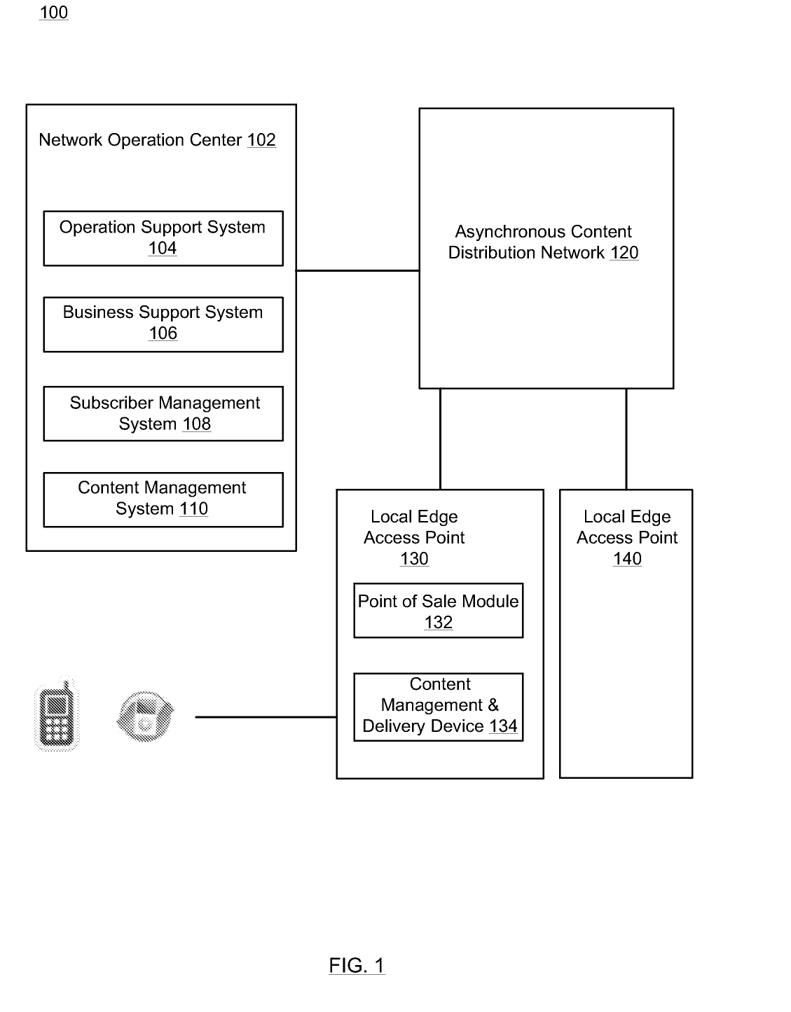

FIG. 1 illustrates a simplified block diagram of an example system 100 in which one embodiment of a content management and delivery device (CMDD) 134 may be configured to operate in. In one implementation, the CMDD 134 operates in a local edge access point (AP) 130. This local edge AP 130 and other local edge APs, such as a local edge AP 140, in FIG. 1 may be deployed in one or more physical locations, such as retail stores. The local edge APs may also be coupled to a network operation center (NOC) 102 via an asynchronous content distribution network (ACDN) 120.

In one implementation, the NOC 102 includes an operation support system (OSS) 104, a business support system (BSS) 106, a subscriber management system 108, and a content management system 110.

The OSS 104 may include one or more computing devices configured to monitor network and system health, operational key performance indicators (KPIs), and performance analytics. In addition, the OSS 104 may also support functions such as, without limitation, visualization of performance analytics, a notification engine, and KPI/analytics Application Programming Interface (API).

The BSS 106 may also include one or more computing devices configured to monitor business KPIs, analyze performance and commercial activities, visualize performance analytics, and support a notification engine and KPI/analytics API.

The subscriber management system 108 may include one or more computing devices configured to maintain subscriber information (e.g., transactions, preferences, and user data associated with each subscriber), support authentication, authorization, and accounting (AAA) functions, integrate AAA with digital currency and billing systems, manage and adjust service plans for subscribers, support at least a customer service portal and API, and determine/suggest pricing for subscriber services and pricing for advertising.

The content management system 110 may include one or more computing devices configured to acquire, decode, ingest, transcode, index, and tag content. The content management system may also support digital rights management (DRM), generate content packages for the local edge AP, and generate customized programming for a subscriber.

Some example computing devices that are deployed in the OSS 104, the BSS 106, and the subscriber management system 108 of the NOC 102 include, without limitation, a network analytics engine, a visualization server, a business analytics engine, an AAA and billing server, a notification, a database server managing one or more databases, such as, without limitation, a network information database and a vault.

Some example components in the content management system 110 of the NOC 102 include an Integrated Receiver & Decoder (IRD) an asynchronous content aggregator, an ingestor, a transcoder, a DRM engine, an encoder, a pull server, and storage devices for online content and/or off-line content.

In one implementation, the local edge AP 130 includes a point of sale module 132 and the aforementioned CMDD 134.

The point of sale module 132 may include one or more computing devices and display devices configured to provide interactive sales and customer services, manage transactions, manage physical inventory, manage device interfaces, monitor network and system status, and recover from network failures.

The CMDD 134 may communicate with a first set of devices (e.g., subscriber devices, hand-held devices, mobile devices, memory storage devices, and others) via a first connection (e.g., a short-ranged connection) and communicate with a second set of devices in the NOC 102 via the ACDN 120. In some implementations, the CMDD 134 may support some or all of the aforementioned functions of the point of sale module 132.

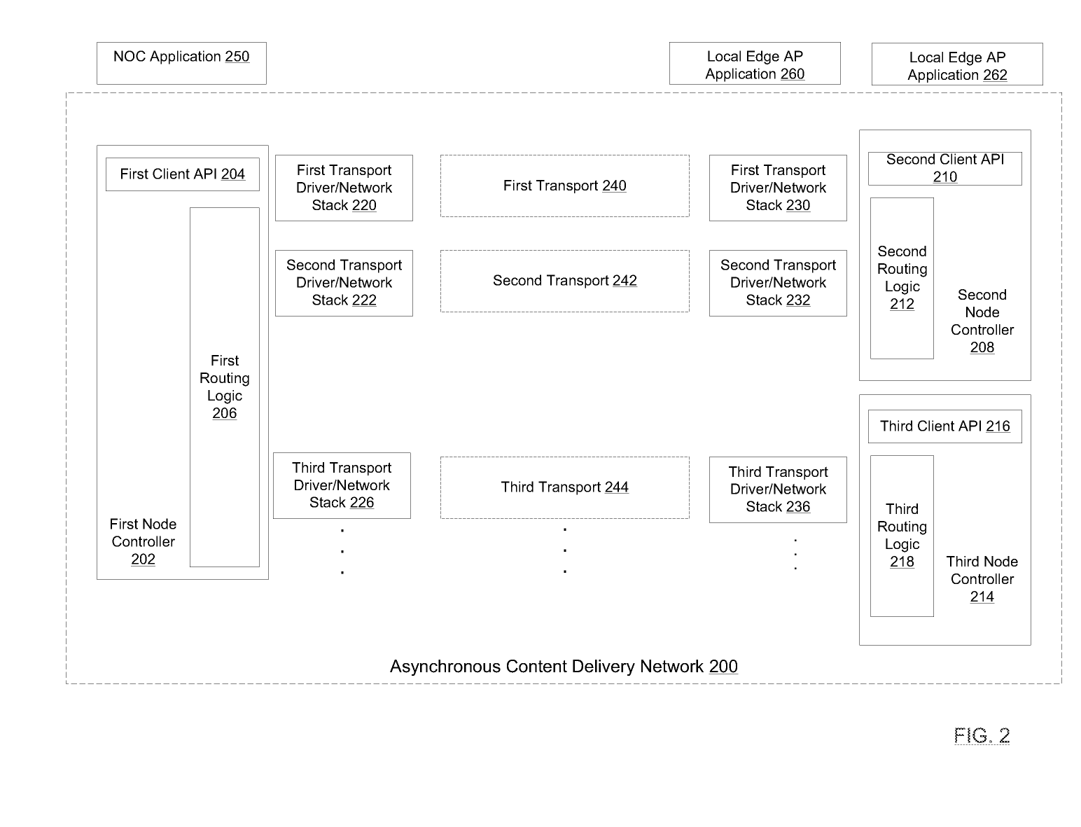

FIG. 2 illustrates an example embodiment of the ACDN 120 of FIG. 1. An ACDN 200 may include multiple node controllers, such as a first node controller 202, a second node controller 208, and a third node controller 214. Each of the node controllers may be configured to support one or more transports, such as a first transport 240, a second transport 242, and a third transport 244. The first node controller 202 may include a first client API 204 and a first routing logic 206; the second node controller 208 similarly may include a second client API 210 and a second routing logic 212; and the third node controller 214 may also include a third client API 216 and a third routing logic 218. For a node controller to transfer data via a certain transport, it may rely on a transport driver and a network stack. If the node controller is configured to support multiple transports, then it may rely on multiple transport drivers and network stacks. For simplicity, each pair of transport driver and the network stack is shown in FIG. 2 as a single block, such as a first transport driver/network stack 220, a second transport driver/network stack 222, and a third transport driver/network stack 226 for the first node controller 202, a first transport driver/network stack 230 and a second transport driver/network stack 232 for the second node controller 208, and a third transport driver/network stack 236 for the third node controller 214.

Each of the node controllers may also be configured to abstract the complexity of data transfer from applications, such as a NOC application 250, which may be configured to execute on or on behalf of the NOC 102 illustrated in FIG. 1, and local edge AP applications 260 and 262, which may be configured to respectively execute on or on behalf of the local edge AP 130 and the local edge AP 140 illustrated in FIG. 1. In other words, the applications are not required to have the detailed transport and underlying network information before proceeding to request to transfer data.

In one embodiment, each node supported by the ACDN 200 (e.g., the NOC 102, the local edge APs 130, and the local edge 140) may be given alphanumeric addressing information that is unique within the ACDN 200. For these nodes to share information (e.g., capabilities of the nodes, network conditions experienced by the nodes, and others) with one another, the ACDN 200 may include a network controller (currently not shown in FIG. 2), with which the various node controllers, such as the first node controller 202, the second node controller 208, and the third node controller 214, may register with. The network controller may store the information from the node controllers and make the information accessible to the node controllers in the ACDN 200. In one implementation, to alleviate the need to repeatedly querying the network controller for information, such as the latest changes associated with one or more nodes, a node controller may subscribe to receive some or all of such information.

In one embodiment of the ACDN 200, group addressing is supported. These groups may be defined in a number of ways, such as, without limitation, statically (e.g., a list of nodes belonging to a group is specified) or dynamically (e.g., multiple nodes register to a particular group). The group information may be stored in the network controller and may be queried or subscribed by a node controller in the ACDN 200. Additional details and examples for the ACDN 200 are provided in subsequent paragraphs.

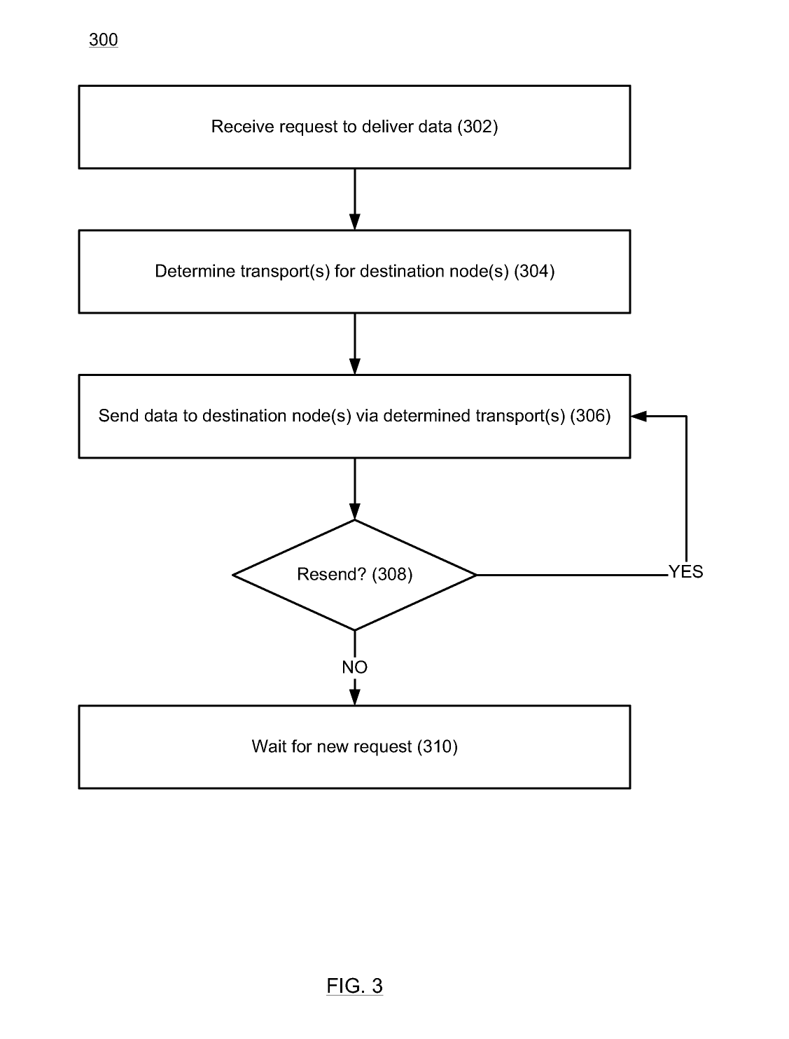

In conjunction with FIG. 1 and FIG. 2, FIG. 3 is a flow chart of an illustrative embodiment of a process 300 for a node controller, such as the first node controller 202, to deliver data to one or more destination nodes, such as the local edge AP 130 and the local edge AP 140. The various blocks of the process are not intended to be limiting to the described embodiments. For example, one skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In block 302 (receive request to deliver data), the first node controller 202, via its first client API 204, may receive a request from the NOC application 250 operating on or on behalf of the NOC 102 to deliver data to one or more destination nodes, such as the local edge AP 130. In addition to the data to be delivered, the request may also include the type of the data (e.g., video, billing information, and others), delivery options of the data (e.g., how urgently should the data be delivered, whether the delivered data needs to be verified or acknowledged, and others), preferences associated with the data (e.g., how destination nodes prefer to receive data), network conditions associated with the various transports (e.g., whether a certain transport is available and/or supported by the nodes), security of the data (e.g., whether the delivered data has been tampered with), and other parameters.

In block 304 (determine transport(s) for destination node(s)), the first routing logic 206 may be configured to extract the aforementioned information from the request and retrieve other information associated with the destination node to determine an appropriate transport to send the data through.

To further illustrate the retrieval of information, suppose both the second node controller 208 for a first destination node (i.e., the local AP 130) and the third node controller 214 for a second destination node (i.e., the local AP 140) register with the aforementioned network controller of the ACDN 200. The second node controller 208 may share with the network controller certain capability and/or network condition information, such as its support of the first transport 240 and the second transport 242 via the first transport driver/network stack 230 and the second transport driver/network stack 232 and the availability of the first transport 240 and the second transport 242. Similarly, when the third node controller 214 may share with the network controller its support of the third transport 244 via the third transport driver/network stack 236 and the availability of the third transport 244. Suppose further that the first node controller 202 subscribes to receive such capability and/or network condition information of the second node controller 208 and the third node controller 214. The first routing logic 206 then may retrieve such information associated with the first destination node and the second destination node from the network controller.

In an example unicast scenario, suppose the first transport 240 corresponds to data transfer over the public Internet via WiMAX, and the second transport 242 corresponds to manual delivery of storage media containing data. If the request from the NOC application 250 is to deliver data to just the first destination node with the high-priority delivery option, then the first routing logic 206 may determine in block 304 to deliver the data through the faster first transport 240 based on the information extracted from the request (i.e., high-priority delivery option) and relevant information associated with the first destination node (i.e., its support for both the first transport 240 and the second transport 242, the availability of the first transport 240, and the speed of the first transport 240).

On the other hand, suppose the faster first transport 240 is down, and the request from the NOC application 250 is to deliver data to the first destination node with the low-priority delivery option. Because of the unavailability of the first transport 240, the first routing logic 206 may determine to deliver data via the second transport 242 (e.g., physical deliver of storage media containing the data to the first destination node).

In an example multicast scenario, suppose the request from the NOC application 250 is to deliver data to both the first destination node and the second destination node with the low-priority delivery option. Suppose further that the faster first transport 240 is still down, and the third transport 244 corresponds to manual delivery of storage media containing data and is available. The first routing logic 206 may determine in block 304 to deliver the data through the second transport 242 and the third transport 244.

In block 306 (send data to destination node(s) via determined transport(s)), the first node controller 202 may send the data from the NOC application 250 via the transport(s) determined in block 304. As mentioned before, the NOC application 250 may have the addressing information of the destination node(s) but is not burdened with the details of how the data is delivered to the destination node(s). If there are multiple destination nodes, the NOC application 250 may have the group information for the nodes. For instance, in the above mentioned multicast example, because the second transport 242 and the third transport 244 are the determined transports, the data from the NOC application 250 are stored in storage media, and the storage media containing the data are delivered by a courier to the first destination node and the second destination node. The first node controller 202 is configured to abstract such delivery details from the NOC application 250.

In block 308 (resend?), the first node controller 202 may be configured to check whether the data needs to be resent to the destination node(s). In one implementation, the request from the NOC application 250 may include a reliability setting in the delivery option, indicating whether the destination node should verify whether the received data may be corrupted, missing, or out-of-order (i.e., the verified option) or whether the first node controller 202 should receive acknowledge of successful receipt from the destination node (i.e., the acknowledged option or the reliable option). Thus, if the reliability setting of the delivery option is the reliable option, and the acknowledgement of successful receipt is not received, then the first node controller 202 may proceed back to block 306 to resend the data. Otherwise, the first node controller 202 may proceed to block 308 (wait for new request) to wait for another request, if any, from the NOC application 250.

In some implementations, the type of data associated with the request may affect the aforementioned priority setting and/or reliability setting of the delivery option. For example, suppose a first type of data is billing related data, and a second type of data is an old episode of a soap opera. The billing related data may need to be delivered at a higher priority and a higher reliability setting than the old episode of the soap opera.

Continuing with the above mentioned example of the first transport 240 supported by the second node controller 208 being unavailable, suppose the first transport 240 becomes available after the data is delivered via the second transport 242. In one implementation, the second node controller 208 may be configured to send the acknowledgement of the successful receipt back to the first node controller 202 via the first transport 240. In other words, in one embodiment of the ACDN 200, any two node controllers may be configured to communicate with one another via multiple transports, even of different types (e.g., data transfer over the public Internet via WiMAX and manual delivery of storage media containing data), that are supported between them.

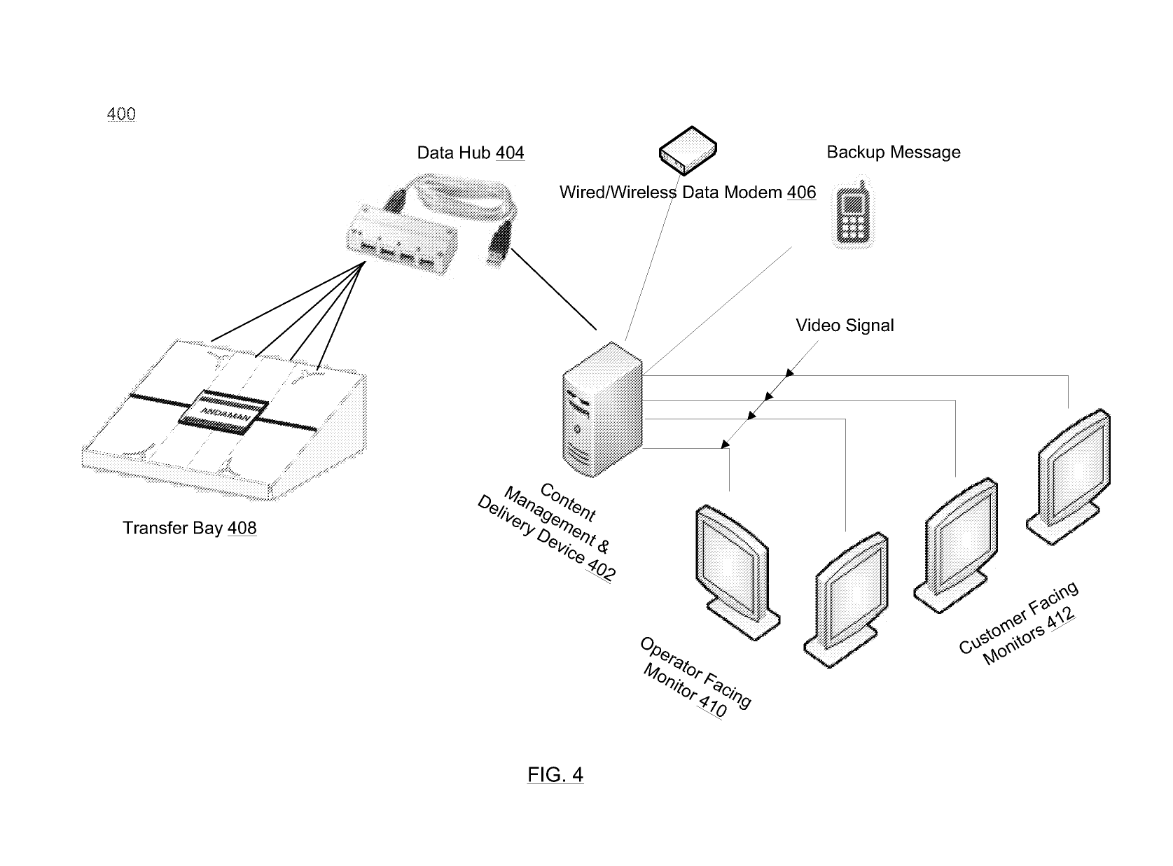

FIG. 4 illustrates an example local edge AP 400 in which one embodiment of a CMDD 402 may be configured to operate in. The local edge AP 400 may correspond to the local edge AP 130 of FIG. 1, and the CMDD 402 may correspond to the CMDD 134. The CMDD 402 is coupled to a data hub 404, which is coupled to a wired/wireless data modem 406 and a transfer bay 408, and one or more monitors. Alternatively, the CMDD 402 is coupled to the wired/wireless data modem 406 directly. In one implementation, the data hub 404 supports the Universal Serial Bus (USB) interface. Moreover, in one implementation, the connection via the wired/wireless data modem 406 serves as the primary connection (e.g., via a T1 line, Digital Subscriber Line (DSL) connection, cable network, wireless link, or others) for the CMDD 402. The device may also support one or more secondary connections (e.g., via a cellular link or others), through which the device may transmit one or more backup messages in the event that the primary connection is down. Here, the CMDD 402 is also configured to support some of the aforementioned functions of a point of sale module (e.g., the point of sale module 132 of FIG. 1) in the local edge AP 400. For example, the device may customize and output video signals to one or more monitors for an operator (e.g., operator facing monitors 410) in the local edge AP 400 and/or one or more monitors for subscribers and potential subscribers visiting the local edge AP 400 (e.g., customer facing monitors 412).

To further illustrate, suppose a subscriber visits the local edge AP 400 to obtain some movie clips that she is interested in. While she waits for the operator to verify her account status and authorize her requested transaction, based on certain preference information (e.g., transaction history, demographic information, and others), the CMDD 402 may output video signals to one or more display devices suggesting to the subscriber additional content that she may want to purchase.

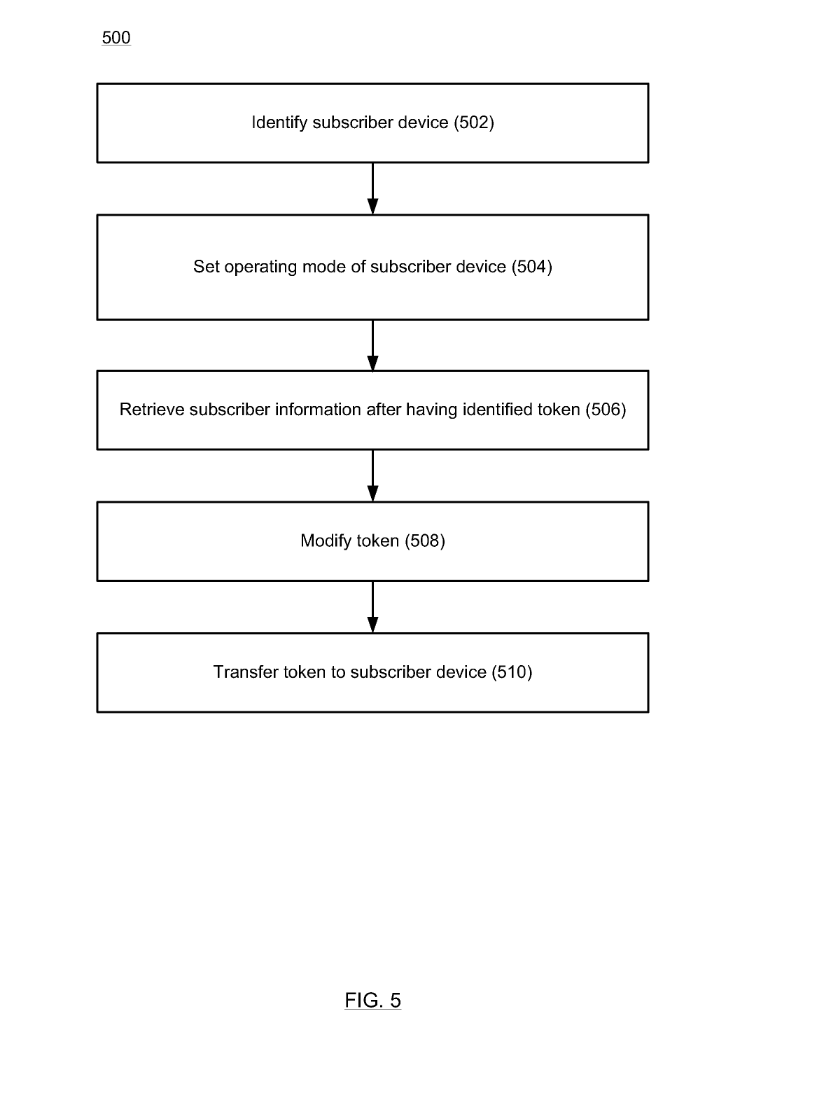

FIG. 5 is a flow chart of an illustrative embodiment of a method 500 for maintaining a registered subscriber account. The various blocks of the method are not intended to be limiting to the described embodiments. For example, one skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In block 502 (identify subscriber device), a CMDD, such as the CMDD 134 of FIG. 1, may use unique or semi-unique information associated with a subscriber device (e.g., USB PID, USB VID, USB serial number, or others) to identify the type of the subscriber device, once the subscriber device is coupled to the CMDD via a data hub, such as the data hub 404 of FIG. 4. Some examples of the subscriber device may include, without limitation, a hand-held device (e.g., a cellular phone, smart phone, personal media player, and others), a mobile device (e.g., a tablet PC, notebook PC, and others), and a memory storage device (e.g., a SD card, subscriber identity module (SIM) card, and others).

In block 504 (set operating mode of subscriber device), based on the device type, the CMDD may issue one or more appropriate instructions to the subscriber device to set its operating mode. For example, the CMDD may instruct the subscriber device to enter the USB mass storage mode, so that information stored in the file system of the subscriber device may be retrieved.

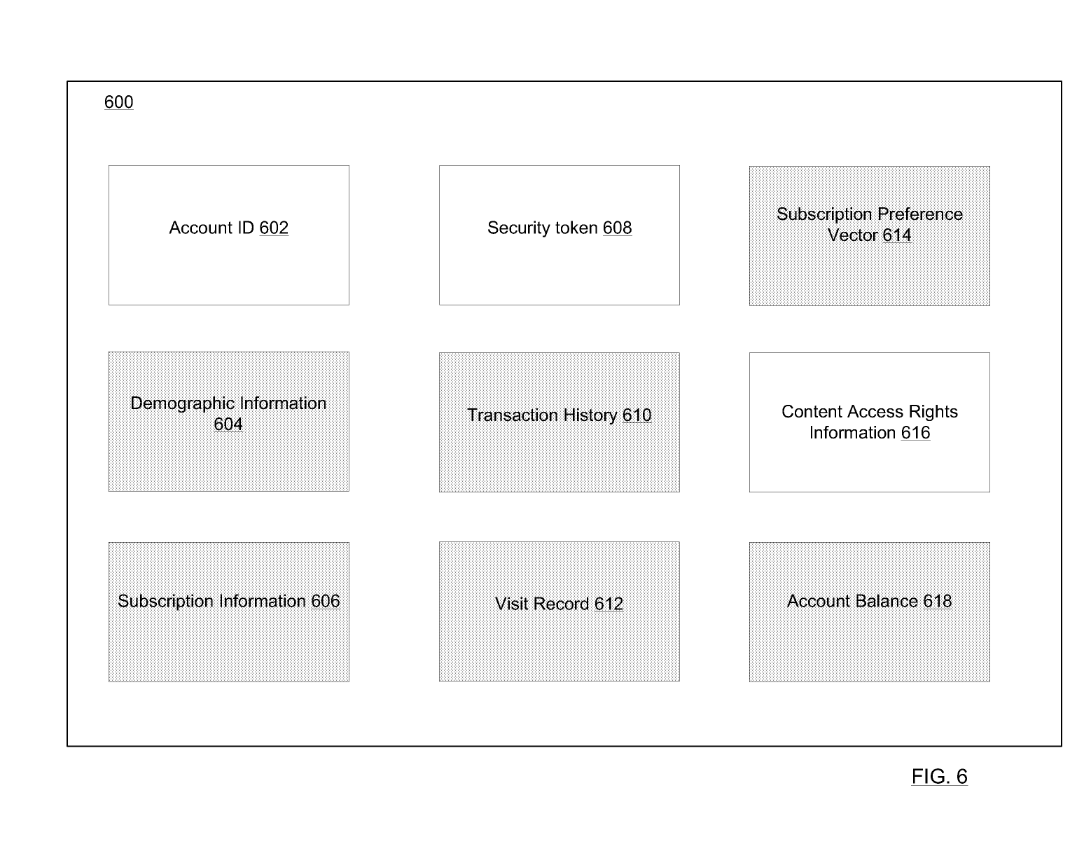

In block 506 (retrieve subscriber information after having identified token), the CMDD may proceed to search for a token stored in the subscriber device. One example token is shown in FIG. 6, and in one implementation, the token is an encrypted data object. Detailed descriptions of the token are set forth in subsequent paragraphs. If the token is identified, the CMDD in one implementation retrieves the subscriber information associated with the token.

FIG. 6 illustrates an example token 600, which may include, without limitation, an account ID 602, demographic information 604, subscription information 606, security token 608, transaction history 610, visit record 612, subscription preference vector 614, content access rights information 616, and account balance 618. In some implementations, the demographic information 604, subscription information 606, transaction history 610, visit record 612, subscription preference vector 614, and account balance 616 may be stored in a NOC, such as the NOC 102 of FIG. 1, and the token 600 may specify where such items are available and the mechanism for retrieving them. As for the account ID 602 and the security token 608, the information for such items may be embedded in the token 600.

In one implementation, the CMDD sets the operating mode of the subscriber device to another operating mode (e.g., from USB mass storage mode to service mode), so that additional information (e.g., device information, such as, without limitation, phone number, International Mobile Equipment Identity (IMEI), and others) can also be retrieved from the subscriber device.

In block 508 (modify token), with the retrieved subscriber information and possibly also the device information, the CMDD may verify such information with the NOC to make sure the subscriber's account is properly registered and then proceed to modify the token. Modifying the token may discourage attempts to use an illegally duplicated token to fraudulently conduct transactions as a registered subscriber.

In block 510 (transfer token to subscriber device), the CMDD may transfer the modified token to the subscriber device. In one implementation, the transfer process also includes known verification and confirmation mechanisms to ensure the modified token is not tampered with during the transfer.

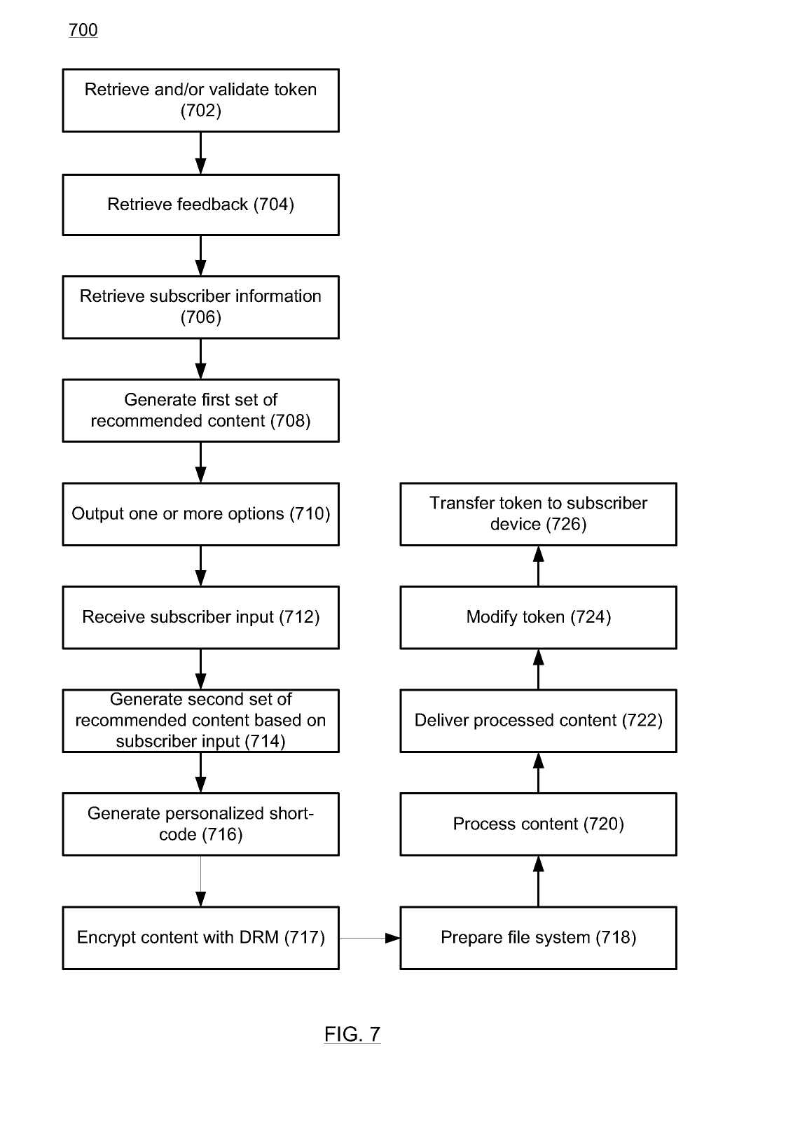

FIG. 7 is a flow chart of an illustrative embodiment of a method 700 for transferring customized content to a subscriber device. The various blocks of the method are not intended to be limiting to the described embodiments. For example, one skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In block 702 (retrieve and/or validate token), a CMDD, such as the CMDD 134 of FIG. 1, may search for, retrieve, and/or validate the token stored in the subscriber device. For validation of the token, the CMDD may interact with a NOC, such as the NOC 102. If a token is deemed to be invalid, such a token may be added to the aforementioned blacklist at the NOC.

In block 704 (retrieve feedback), the CMDD may retrieve any feedback from the subscriber device for content rating purposes. For example, suppose a subscriber previously downloaded a list of songs by a certain artist to the subscriber device and rated the songs after having listened to them. This rating information may be stored on the subscriber device. Such feedback information from subscribers may be retrieved and aggregated for the songs and the artist.

In block 706 (retrieve subscriber information), after having retrieved and/or validated the token, the CMDD may retrieve relevant subscriber information, such as, without limitation, the demographic information, subscription information, transaction history, visit record, and subscription/preference vector.

In block 708 (generate first set of recommended content), based on the retrieved subscriber information, the CMDD may generate a first set of recommended content. This may be in a form of a playlist having one or more content objects. Some example content objects may include, without limitation, photos, songs, and multimedia clips. In one implementation, based on the retrieved subscriber information, the CMDD formulates a subscriber characteristics vector indicating the characteristics of content that a subscriber is most likely to purchase (e.g., whether the content features the subscriber's favorite artist, whether the content is of the subscriber's favorite type, and others). This can be generated using an exact match method or a statistical likelihood method. The CMDD also extracts content characteristics vector (e.g., cast and genre and other meta information) for each content object that is locally accessible at the local edge AP. Based on the aforementioned subscriber characteristics vector and also the content characteristics vectors, the first set of recommended content is generated.

In block 710 (output one or more options), the CMDD may cause the recommended content and also one or more options (e.g., options to modify, add, or delete the recommended content, options to purchase the recommended content, and others) to be displayed.

In block 712 (received subscriber input), the CMDD may receive input from a subscriber directly (via certain user interfaces supported in the local edge AP) or the operator of the local edge AP.

In block 714 (generate second set of recommended content based on subscriber input), the first set of recommended content may be modified based on the received subscriber input. In one implementation, the subscriber may be given an opportunity to accept or reject the second set of recommended content.

In block 716 (generate personalized short-code), with the second set of recommended content that is likely to have been accepted, one way to identify each content object is to use short-codes.

In block 717 (encrypt content with DRM), the CMDD may encrypt the content in accordance with proprietary or standard Digital Rights Management (DRM) technology. For example, Open Mobile Alliance 1.0 or 2.0 DRM may be used in order to control access and distribution privileges.

In block 718 (prepare file system), the CMDD may check the available memory space on the subscriber device, perform delete/move/name changing operations on data/content objects on the subscriber device based on predetermined rules (e.g., delete files that are x days old; delete content objects that have not been accessed for y days, and others), and/or retrieve user-generated content from a preconfigured directory of the subscriber device. In one implementation, the CMDD prompts the subscriber via the subscriber device to confirm some or all of the aforementioned operations. For example, certain user-generated content may be considered to be private, and the subscriber may not allow such user-generated content to be accessed or modified.

In block 720 (process content), the CMDD may process the second set of recommended content.

In block 722 (deliver processed content), the CMDD may deliver the processed content to the subscriber device.

In block 724 (modify token), the CMDD may modify the token to address the aforementioned potential fraud issues.

In block 726 (transfer token to subscriber device), the CMDD may transfer the modified token to the subscriber device.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof. In addition, software and/or firmware to implement the techniques introduced here may be stored on a non-transitory machine-readable storage medium and may be executed by one or more general-purpose or special-purpose programmable processors. A “machine-readable storage medium”, as the term is used herein, includes any mechanism that provides (i.e., stores and/or transmits) information in a form accessible by a machine (e.g., a computer, network device, mobile device, any device with a set of one or more processors, and others). For example, a machine-accessible storage medium includes recordable/non-recordable media (e.g., read-only memory (ROM), random access memory (RAM), magnetic disk storage media, optical storage media, flash memory devices, and others).

While the forgoing is directed to embodiments of the present disclosure, other and further embodiments of the present disclosure may be devised without departing from the basic scope thereof, and the scope thereof may be determined by the claims that follow.

We claim:

1. A method for delivering data to a plurality of destination nodes, comprising:
in response to a request to deliver the data, determining a first transport for a first destination node based on availability of and/or network condition associated with the first transport;
sending the data to the first destination node via the first transport; and
determining whether to resend the data based on a delivery option extracted from the request.

2. The method of claim 1, wherein the determining whether to resend is further based on whether an acknowledgement of successful receipt of the data by the first destination node is received via the first transport.

3. The method of claim 1, wherein the determining whether to resend is further based on whether an acknowledgement of successful receipt of the data by the first destination node is received via a second transport supported by the first destination node.

4. The method of claim 2, wherein the acknowledgement is stored in a storage medium delivered by a courier.

5. The method of claim 3, wherein the determining a first transport is further based on the delivery priority extracted from the request.

6. The method of claim 1, further comprising:
in response to the request, determining a second transport for a second destination node based on availability of and/or network condition associated with the second transport; and
sending the data to the second destination node via the second transport.

7. The method of claim 6, wherein the sending further comprising:
storing the data in a storage medium; and
delivering the storage medium to the second destination.

8. A node controller configured to deliver data to a plurality of destination nodes, comprising:
an application programming interface (API); and
a routing logic, wherein in response to a request to deliver the data received via the API, the routing logic is configured to:
determine a first transport for a first destination node based on availability of and/or network condition associated with the first transport,
send the data to the first destination node via the first transport; and
determine whether to resend the data based on a delivery option extracted from the request.

9. The node controller of claim 8, wherein the routing logic is configured to determine whether to resend based on whether the node controller receives an acknowledgement of successful receipt of the data by the first destination node via the first transport.

10. The node controller of claim 8, wherein the routing logic is configured to determine whether to resend based on whether the node controller receives an acknowledgement of successful receipt of the data by the first destination node via a second transport supported by the first destination node.

11. The node controller of claim 10, wherein the routing logic is configured to determine the first transport based on the delivery priority extracted from the request.

12. The node controller of claim 8, wherein the routing logic is further configured to:
in response to the request, determine a second transport for a second destination node based on availability of and/or network condition associated with the second transport; and
send the data to the second destination node via the second transport.

13. The node controller of claim 12, wherein the data is stored in a storage medium, and the storage medium is delivered to the second destination.

14. A method for delivering data to a device, comprising:
retrieving a token from the device;
retrieving information of a subscriber from the device after having validated the token;
generating a first set of recommended content based on a set of preferences associated with the subscriber;
preparing a file system of the device;
processing the first set of recommended content to generate processed content; and
modifying the token after having delivered the processed content to the device.

15. A method for creating an account of a subscriber associated with a device, comprising:
identifying the device;
setting the device to a first operating mode;
retrieving information of the subscriber if a token is retrieved from the device;
modifying the token; and
transferring the modified token to the device.
